(19) United States
(12) Patent Application Publication
(10) Pub. No.: US 2018/0060811 A1
(43) Pub. Date: Mar. 1, 2018

(54) Drone delivery using earpiece

(71) Applicant: BRAGI GmbH, Munchen (DE)

(72) Inventor: Peter Vincent Boesen, Munchen (DE)

(73) Assignee: BRAGI GmbH, Munchen (DE)

(21) Appl. No.: 15/691,336

(22) Filed: Aug. 30, 2017

Related U.S. Application Data
(60) Provisional application No. 62/381,150, filed on Aug. 30, 2016.

(51) Int. Cl. G06Q 10/08; B64C 39/02; H04R 1/10; G01S 3/808

(52) U.S. Cl. CPC G06Q 10/0833; B64C 39/02; H04R 2460/07; G01S 3/808; B64C 2201/128; H04R 1/1091

(57) ABSTRACT

A method of using a set of earpieces to enable a drone delivery includes determining by a drone a position of a user of the set of earpieces, determining by the set of earpieces a position of the drone relative to the set of the earpieces, electronically communicating delivery information from the drone to the set of the earpieces, generating audio messages at the set of the earpieces based on the delivery information from the drone and the position of the drone relative to the set of the earpieces, and conveying by the drone a payload from the drone to the user of the set of earpieces. The set of earpiece includes a left earpiece and a right earpiece wherein each of the left earpiece and the right earpiece comprises an earpiece housing, a speaker, a microphone, a processor, a transceiver, and an inertial sensor.

### PRIORITY STATEMENT

This application claims priority to U.S. Provisional Patent Application 62/381,150, filed on Aug. 30, 2016, and entitled Drone delivery using earpiece, hereby incorporated by reference in its entirety.

### FIELD OF THE INVENTION

The present invention relates to wearable devices. More particularly, but not exclusively, the present invention relates to earpieces.

### BACKGROUND

Commercial drone delivery is fast becoming a reality. Companies are preparing to deliver packages using drone technology in order to reduce delivery times and save consumers money. In order to deliver packages, however, the drones need to know where to go and more importantly need to be able to pinpoint the exact location of a user. GPS positioning may not be sufficient to accurately locate a user. What is needed is a system and method of assisting a drone in locating a user when the drone is within close proximity to the user and GPS positioning alone is insufficient.

### SUMMARY

Therefore, it is a primary object, feature, or advantage of the present invention to improve over the state of the art.

It is a further object, feature, or advantage of the present invention to assist a drone in locating a user when the user is in close proximity of the drone and/or to assist a user in locating a drone when the drone is in close proximity of the user.

It is a still further object, feature, or advantage of the present invention to determine a user position using triangulation or other techniques using wireless transceivers installed within the earpieces.

Another object, feature, or advantage is to provide instructions from the drone to the set of earpieces.

Yet another object, feature, or advantage is to determine a user's orientation relative to a drone and/or a drone's orientation relative to a user to assist in delivery.

A further object, feature, or advantage is to confirm that a safe and complete delivery of a payload of a drone is delivered to a user.

A still further object, feature, or advantage is to maintain a record of the delivery.

Another object, feature, or advantage is to verify identity of a user receiving a delivery from a drone.

One or more of these and/or other objects, features, or advantages of the present invention will become apparent from the specification and claims that follow. No single embodiment need provide each and every object, feature, or advantage. Different embodiments may have different objects, features, or advantages. Therefore, the present invention is not to be limited to or by an object, feature, or advantage stated herein.

According to one aspect, a method of using a set of earpieces to enable a drone delivery includes steps of determining by a drone a position of a user of the set of earpieces, determining by the set of earpieces a position of the drone relative to the set of the earpieces, electronically communicating delivery information from the drone to the set of the earpieces, generating audio messages at the set of the earpieces based on the delivery information from the drone and the position of the drone relative to the set of the earpieces, and conveying by the drone a payload from the drone to the user of the set of earpieces. The set of earpieces includes a left earpiece and a right earpiece. Each of the left earpiece and the right earpiece may include an earpiece housing, a speaker, a microphone, a processor, a transceiver, and an inertial sensor. The audio messages may indicate the position of the drone relative to the set of the earpieces. The method may further include placing an order to be delivered via the drone delivery using the set of earpieces. The position of the drone relative to the set of the earpieces may be performed using signals from the drone received at the transceiver of the left earpiece and at the transceiver of the right earpiece. The audio messages may include instructions to the user regarding the delivery. The position of the drone relative to the set of earpieces may include location and orientation of the set of earpieces and the orientation may be determined at least in part using the inertial sensor of the left earpiece and the inertial sensor of the right earpiece. The audio messages may include instructions for the user to alter location or orientation prior to the delivery. The method may further include communicating delivery confirmation information from the set of the earpieces to the drone.

### BRIEF DESCRIPTION OF THE DRAWINGS

FIG. 1 illustrates one example of a pair of earpieces in communication with a drone configured to deliver a payload.

FIG. 2 illustrates a system that includes a left earpiece and a right earpiece.

FIG. 3 includes a block diagram of one example of a wireless earpiece.

FIG. 4 is a block diagram illustrating various components and systems of one example of a drone.

### DETAILED DESCRIPTION

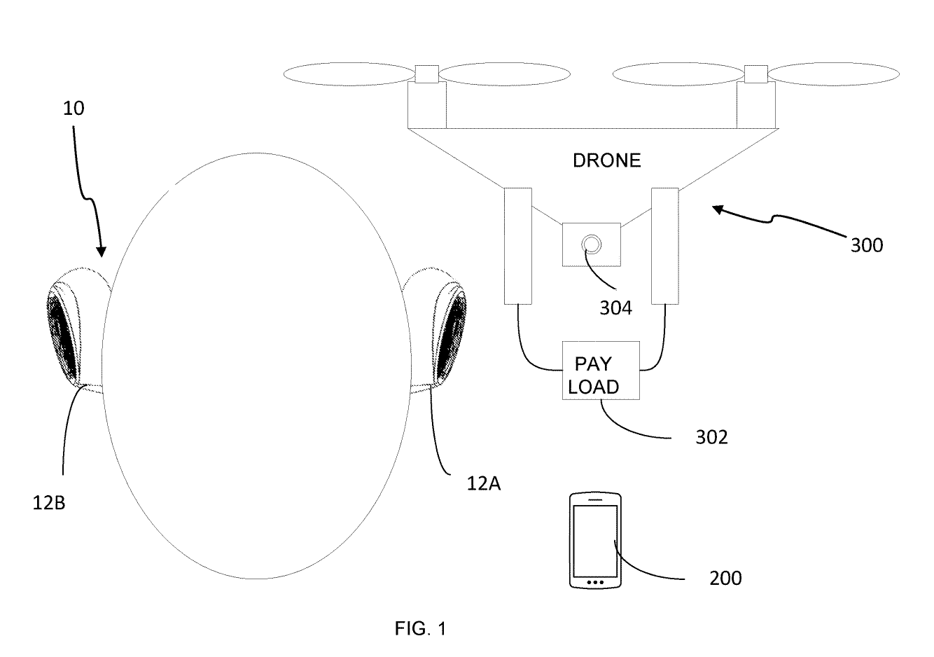

FIG. 1 illustrates an example of a set of earpieces 10 including earpieces 12A, 12B which are in operative communication with a drone 300. The drone 300 may be of any variety of drones or unmanned aerial vehicles or other types of drones including those which are land-based or water-based. The drone 300 may be operator controlled remotely but preferable is autonomous. The drone 300 may include any number of different styles or configurations with any number of different flight mechanisms employed. The drone 30 may include any number of different sensor systems and may include image sensors such as cameras which may operate at the visible, infrared, or other spectrums. The drone 300 may be configured to carry a payload 302. Thus, for example, the drone 300 may be configured to deliver the payload 302 to a user of the earpieces 10. The drone 300 may also be configured to find and then follow the individual only delivering the payload 302 once the user of the earpieces 10 has confirmed that they are ready to receive the payload 302. The drone 300 may take an image or video imagery of the delivery using an onboard camera 304 to confirm the delivery or to otherwise provide a record of the delivery. For audit purposes, the drone 300 may also record other information about the delivery including identifying information about the earpieces, recordings of audio from the user such as may be sensed by and communicated from the earpieces 10 to the drone 300 or other information sensed by the earpieces 10 and communicated to the drone 300 or sensed by the drone 300.

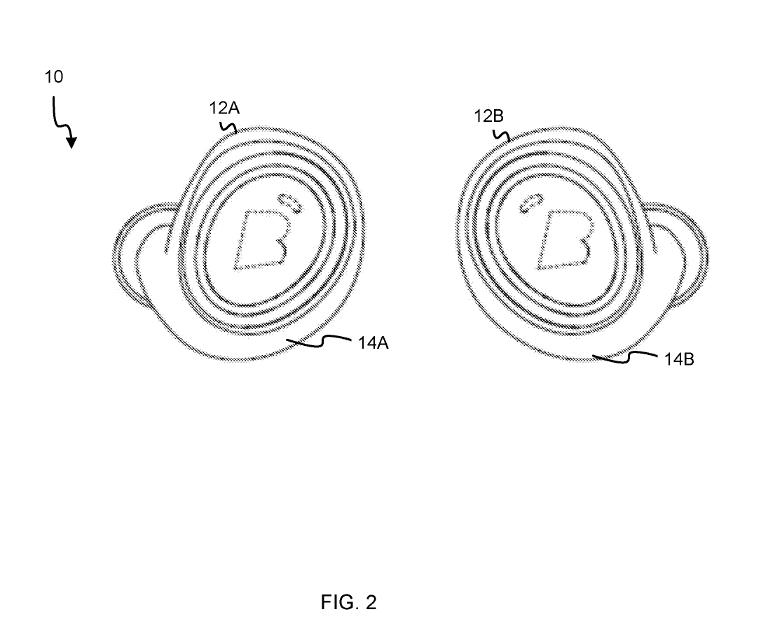

FIG. 2 illustrates a set of earpieces 10 which includes a left earpiece 12A and a right earpiece 12B. The left earpiece 12A has a left earpiece housing 14A. The right earpiece 12B has a right earpiece housing 14B. The left earpiece 12A and the right earpiece 12B may be configured to substantially encompass an outer opening of a user's ear canal in order to substantially prevent external sounds from reaching the user's ear canal and/or fit within the user's ear canal in order to minimize the distance between the speakers and a user's tympanic membranes. Other form factors are contemplated including headsets.

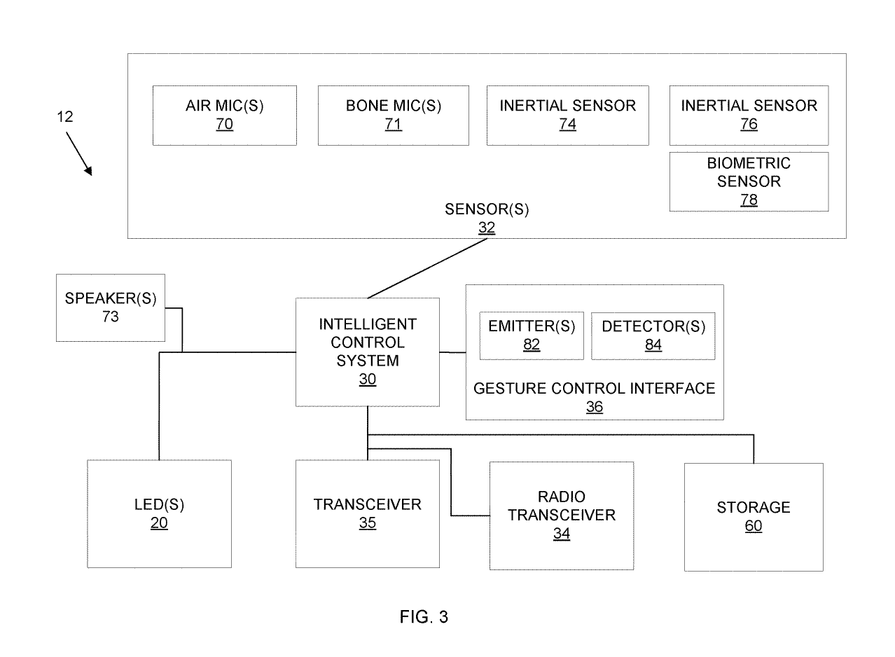

FIG. 3 illustrates another example of a block diagram for an earpiece 12 in additional detail. As shown in FIG. 3, various sensors 32 may be operatively connected to the intelligent control system 30. The sensors may include one or more air microphones 70, one or more bone microphones 71, one or more inertial sensors 74, 76, and one or more biometric sensors 78. A gesture control user interface 36 is shown which is operatively connected to the intelligent control system 30. The gesture control interface 36 may include one or more emitters 82 and one or more detectors 84 that are used for receiving different gestures from a user as user input. Example of such gestures may include taps, double taps, tap and holds, swipes, and other gestures. Of course, other types of user input may be provided including voice input through one or more of the microphones 70, 71 or user input through manual inputs such as buttons. As shown in FIG. 3, one or more LEDs 20 may be operatively connected to the intelligent control system 30 such as to provide visual feedback to a user. In addition, a transceiver 35 may be operatively connected to the intelligent control system 30 and allow for communication between the wireless earpiece 12 and another earpiece. The transceiver 35 may be a near field magnetic induction (NFMI) transceiver or other type of receiver such as, without limitation, a Bluetooth, ultra-wideband (UWB) or other type of wireless transceiver. A radio transceiver 34 may be present which is operatively connected to the intelligent control system 30. The radio transceiver 34 may, for example, be a Bluetooth transceiver, an UWB transceiver, Wi-Fi, frequency modulation (FM), or other type of transceiver to allow for wireless communication between the earpiece 12 and other types of computing devices such as desktop computers, laptop computers, tablets, smart phones, vehicles (including drones), or other devices. The storage 60 may be operatively connected to the intelligent control system 30 to allow for storage including of audio files or other information.

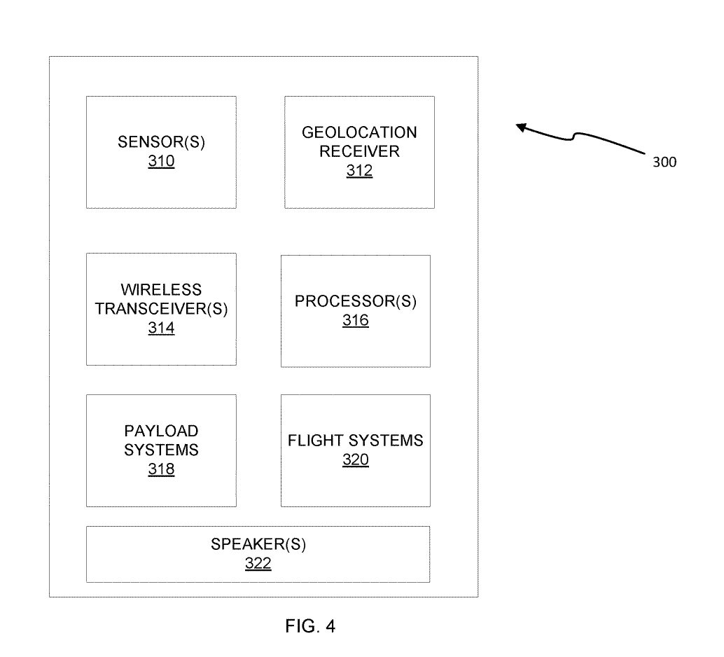

FIG. 4 illustrates a block diagram of one example of a drone 300. The drone 300 may include one or more sensors 310 which may include image sensors, microphones, and any number of other sensors. The drone 300 may include a geolocation receiver 312 such as a GPS receiver or GLOSNASS receiver. The drone 300 may include one or more wireless transceivers 314 preferably with at least one of the wireless transceivers 314 adapted to communicate with one or more earpieces. The drone 300 may include one or more processors 316 which are operatively connected to other components shown in FIG. 4 to provide for control of the systems. The drone 300 may include one or more payload systems 318 which are used to secure and release the payload. The drone 300 includes one or more flight systems 320 for controlling basic flight operations of the drone 300 or other type of systems based on the type of drone. The drone 300 may also include one or more speakers 322. The one or more speakers 322 may be operatively connected to the one or more processors 316 and may be used to emit audio which may be detected by one or more earpieces. The audio may be within the range of human hearing or may be above the range of human hearing such as over 20 kHz in frequency.

Returning to FIG. 1, in operation the set of earpieces 10 is used to enable delivery of a payload 302 from the drone 300. As an initial matter, a location of the drone may be determined in various ways including through use of a geolocation receiver such as a GPS receiver. The location of a user of the earpieces may also be determined. One way that a general location of a user of the earpieces may be determined is by using a GPS receiver of either the earpieces themselves or of another device in operative communication with the earpieces. For example, a mobile device such as a mobile phone 200 may have a GPS receiver. The mobile phone 200 provides a GPS location of some level of accuracy and can be communicated over a network, such as the internet, to the drone 300. Alternatively, the drone 300 does not need a real-time GPS location of a user and can instead meet the user at a particular location and time as pre-scheduled such as when a user places an order for an item to be delivered.

However, as previously explained, for a variety of reasons, a GPS location may not be a precise enough location for a done delivery. Therefore, the earpieces 12A, 12B may be used to assist in the final stages of a delivery of an item or the payload 302 of the drone 300. One way that the earpieces 12A, 12B may be used to assist in the final stages of delivery is by determining the drone position of the user using the set of earpieces. This can be performed in various ways. For example, radio signals between the set of earpieces and the done may be used in order to apply radio direction finding techniques. With two earpieces present and known relative locations of the earpieces, the location of the drone can be determined when the drone is near the user. Other methods may also be used. For example, where the earpieces include one or more inertial sensors, a user may be asked by the earpieces to look in different directions and to communicate to the earpieces when the user is looking at the drone. Inertial sensors of the earpieces may then be used in order to establish the direction of the drone 300. Another method of locating the drone may be for the drone to emit sounds either audible to a human or not audible to a human (i.e. at a higher frequency than normal hearing) which may be detected by the earpieces and used for determining location of the drone.

When the drone 300 approaches the location of the user, the drone 300 may determine a position of the user of the set of earpieces. This may be accomplished in various ways. For example, imagery may be analyzed to determine position of a user. Alternatively, a wireless connection may be made with one or both of the wireless earpieces 12A, 12B. Signal information for one or two wireless connection between the drone 300 may be used to determine position of the user. The wireless connection may be of various types including Bluetooth connections, Wi-Fi connections, or other type of wireless connections. Thus, the drone 300 may be brought closer to a user's actual position than GPS coordinates. In addition, the set of earpieces may determine a position of the drone relative to the set of earpieces. This may be accomplished in various ways. This may be based on signal information for the one or two wireless connections between the earpieces 12A, 12B and the drone 300. For example, radio direction finding may be performed. Alternatively, audio sounds may be analyzed by the earpieces 12A, 12B to determine location of the drone 300, where the earpieces include microphones which detect environmental sounds. As previously explained, the drone 300 may emit sound specifically for the purpose of identification and location.

The earpieces 12A, 12B may also assist in drone delivery in any number of other ways. For example, delivery information may be communicated from the drone 300 to the set of the earpieces 12A, 12B. Thus, where a Bluetooth or other type of connection established between the drone 300 and the earpiece set 10 information regarding a rendezvous between the drone 300 and the user may be established. This may involve merely instructing the user on proper procedures for receiving a delivery such as indicating that the drone 300 will land at a particular location and the user should proceed to that location, or notification that the drone 300 will land or that the drone 300 will drop its payload 302 at a particular location or time. This information may be communicated to a user as audio messages generated at the set of the earpieces 10. This audio information may also take into account the position of the drone 300 relative to the set of the earpieces 10. The drone 300 may then convey the payload from the drone to the user of the set of wireless earpieces 10.

The audio messages may be specific in that they may request a user to turn their head to a particular direction to see the drone 300. This may be useful in situations where multiple drones are present or when a user cannot hear a drone approaching. The wireless earpieces 10 may include one or more inertial sensors which may be used to determine head position and orientation of the user. Thus, based on the earpieces knowing the relative position of the drone 300 to the earpieces 10, the earpieces 10 may determine if the user's head is oriented in a direction toward the drone or not. The instructions may also instruct a user to raise their hands or outstretch their arms in order to receive delivery so that the drone may release its payload 302 into the hands or arms of the user.

Depending upon the sensors present in the wireless earpieces 10, other functions may be performed. For example, biometric data from the biometric sensor of the earpiece may be used to verify identify of a user of the wireless earpieces. Where the drone 300 includes a camera, images or video of the encounter between the drone 300 and the user may be recorded as a record of the delivery. In addition, or alternatively, the user may confirm delivery to the wireless earpieces 10 such as through a voice confirmation. This confirmation may then be communicated to the drone 300 for wireless communication therebetween.

It is to be further understood that the wireless earpieces may be used not only to assist in delivery by drone but also as a part of a more complete process. For example, the wireless earpieces 10 may be used to place orders such as via voice command to a retailer.

Therefore various apparatus, methods, and systems have been shown and described relating to drone delivery including done delivery using earpieces. It is to be understood that numerous variations, options, and alternatives are contemplated including variations in the manner in which a drone locates earpieces associated with a user, the manner in which earpieces locate a drone, information conveyed between earpieces and drones, and other variations.

What is claimed is:

1. A method of using a set of earpieces to enable a drone delivery comprising:
determining by a drone a position of a user of the set of earpieces;
determining by the set of earpieces a position of the drone relative to the set of the earpieces;
electronically communicating delivery information from the drone to the set of the earpieces;
generating audio messages at the set of the earpieces based on the delivery information from the drone and the position of the drone relative to the set of the earpieces; and
conveying by the drone a payload from the drone to the user of the set of earpieces;
wherein the set of earpiece comprises a left earpiece and a right earpiece wherein each of the left earpiece and the right earpiece comprises an earpiece housing, a speaker, a microphone, a processor, a transceiver, and an inertial sensor.

2. The method of claim 1 wherein the audio messages indicate the position of the drone relative to the set of the earpieces.

3. The method of claim 1 further comprising placing an order to be delivered via the drone delivery using the set of earpieces.

4. The method of claim 1 wherein the determining by the set of earpieces the position of the drone relative to the set of the earpieces is performed using signals from the drone received at the transceiver of the left earpiece and at the transceiver of the right earpiece.

5. The method of claim 1 wherein the determining by the set of earpieces the position of the drone relative to the set of the earpieces is performed using audio of the drone detected using one or more microphones of the set of the earpieces.

6. The method of claim 1 wherein the audio messages include instructions to the user regarding the delivery.

7. The method of claim 1 wherein the position of the drone relative to the set of earpieces comprise location and orientation of the set of earpieces and wherein the orientation is determined at least in part using the inertial sensor of the left earpiece and the inertial sensor of the right earpiece.

8. The method of claim 7 wherein the audio messages include instructions for the user to alter location or orientation prior to the delivery.

9. The method of claim 1 further comprising communicating delivery confirmation information from the set of the earpieces to the drone.
